(19) United States
(12) Patent Application Publication
(10) Pub. No.: US 2024/0101818 A1
(43) Pub. Date: Mar. 28, 2024

(54) AQUEOUS HEAT-SEALABLE RESIN COMPOSITION AND LAMINATE

(71) Applicant: ARAKAWA CHEMICAL INDUSTRIES, LTD., OSAKA (JP)

(72) Inventors: Keisuke Okada, Osaka (JP); Mayu Matsumoto, Osaka (JP); Teruaki Sato, Osaka (JP)

(73) Assignee: ARAKAWA CHEMICAL INDUSTRIES, LTD., OSAKA (JP)

(21) Appl. No.: 18/472,207

(22) Filed: Sep. 21, 2023

(30) Foreign Application Priority Data
Sep. 27, 2022 (JP) 2022-153219

(51) Int. Cl. C08L 75/08; C08G 18/10; C08G 18/34; C08G 18/48; C08G 18/75; C09D 175/08

(52) U.S. Cl. CPC C08L 75/08; C08G 18/10; C08G 18/348; C08G 18/4854; C08G 18/755; C09D 175/08; C08L 2201/54; C08L 2203/162

(57) ABSTRACT

There is provided an aqueous heat-sealable resin composition which enables a laminate to have excellent heat sealing strength and blocking resistance. The disclosure relates to an aqueous heat-sealable resin composition which contains a urethane resin (A) which is a product of reaction components including a polyether polyol (a1), a polyisocyanate (a2) and a chain extender (a3) or the urethane resin (A) and a wax (B), and a laminate having a coating of the composition on at least one surface of a substrate.

### CROSS-REFERENCE TO RELATED APPLICATION

This application claims the priority benefit of Japan Application No. 2022-153219, filed on Sep. 27, 2022. The entirety of the above-mentioned patent application is hereby incorporated by reference herein and made a part of this specification.

### BACKGROUND

### Technical Field

The disclosure relates to an aqueous heat-sealable resin composition and a laminate.

### Description of Related Art

In recent years, in order to reduce environmental load, use of aqueous resin compositions has been required. Heat-sealable films (those obtained by applying a heat-sealable resin composition (heat-sealing agent) to a substrate) used for medical device packaging and food packaging have been becoming aqueous since the past, and for example, aqueous heat-sealable resin compositions containing polyolefin resins and polyurethane resins have been developed (Patent Documents 1 and 2).

However, such a resin composition has room for improvement not only in terms of the heat sealing strength but also in terms of restricting blocking between the adhesive layer and the film superimposed thereon during winding on a roll.

### PATENT DOCUMENTS

[Patent Document 1] Japanese Patent Laid-Open No. 2006-045313
[Patent Document 2] Japanese Patent Laid-Open No. 2014-004799

The disclosure provides an aqueous heat-sealable resin composition which enables a laminate to have high heat sealing strength and excellent blocking resistance.

The disclosure relates to the following aqueous heat-sealable resin composition and laminate.

### SUMMARY

1. An aqueous heat-sealable resin composition including a urethane resin (A) which is a product of reaction components including a polyether polyol (a1), a polyisocyanate (a2) and a chain extender (a3).

2. The aqueous heat-sealable resin composition according to Item 1,
wherein the reaction component further includes a (meth)acrylic acid hydroxyalkyl ester (a4).

3. The aqueous heat-sealable resin composition according to Item 1 or 2, further including a wax (B).

4. A laminate having a coating of the aqueous heat-sealable resin composition according to Item 1 or 2 on at least one surface of a substrate.

### DESCRIPTION OF THE EMBODIMENTS

The aqueous heat-sealable resin composition of the disclosure enables a laminate to have heat sealing strength and excellent blocking resistance.

An aqueous heat-sealable resin composition of the disclosure includes a urethane resin (A) (hereinafter referred to as a component (A)) which is a product of reaction components including a polyether polyol (a1) (hereinafter referred to as a component (a1)), a polyisocyanate (a2) (hereinafter referred to as a component (a2)) and a chain extender (a3) (hereinafter referred to as a component (a3)).

The component (a1) is a polyether polyol, and is a component for a coating of the aqueous heat-sealable resin composition to exhibit high heat sealing strength and excellent blocking resistance. Examples of components (a1) include polyethylene glycol, polypropylene glycol, polybutylene glycol, polytetramethylene glycol, polyhexamethylene glycol, polyheptamethylene glycol, polydecamethylene glycol, polyoxyethylene-polyoxypropylene glycol, polyoxytetramethylene-polyoxyethylene glycol, and polyoxytetramethylene-polyoxypropylene glycol. Here, a polyether polyol having a random structure or a block structure can be used. These may be used alone or two or more thereof may be used in combination.

Examples of commercial products of polyether polyols include “Adeka Polyether P-400,” “Adeka Polyether G-400,” “Adeka Polyether T-400,” “Adeka Polyether AM-302,” “Adeka Polyether P1000,” and “Adeka Polyether P2000” (all commercially available from ADEKA Corporation); “Polyethylene glycol #1,540” (commercially available from Nacalai Tesque, Inc.); “Polypropylene glycol 400” (commercially available from Junsei Chemical Co., Ltd.); and “PEG #200,” “PEG #300,” “PEG #400,” “PEG #600,” “PEG #1000,” “PEG #1500,” “PEG #2000,” “PEG #4000,” “UNIOL D-200,” “UNIOL D-700,” “UNIOL D-1000,” “UNIOL D-1200,” “UNIOL D-2000,” “UNIOL D-4000,” “UNIOL PB-500,” “UNIOL PB-700,” “UNIOL PB-1000,” “UNIOL PB-2000,” “POLYCERIN DC-1100,” “POLYCERIN DC-1800E,” “POLYCERIN DC-3000E,” “POLYCERIN DCB-1000,” “POLYCERIN DCB-2000,” and “POLYCERIN DCB-4000” (all commercially available from NOF Corporation).

Examples of components (a2) include aliphatic diisocyanates such as methylene diisocyanate, butane-1,4-diisocyanate, hexamethylene diisocyanate, 2,2,4-trimethylhexamethylene diisocyanate, 2,4,4-trimethylhexamethylene diisocyanate, and dimer diisocyanate in which a carboxyl group of a dimer acid is substituted with an isocyanate group; alicyclic diisocyanates such as cyclohexane-1,4-diisocyanate, isophorone diisocyanate, dicyclohexylmethane-4,4′-diisocyanate, 1,3-di(isocyanatomethyl)cyclohexane, and methylcyclohexane diisocyanate; aromatic diisocyanates such as 4,4′-diphenylmethane diisocyanate, 4,4′-diphenyldimethylmethane diisocyanate, 4,4′-diphenyltetramethylmethane diisocyanate, 1,4-phenylene diisocyanate, tolylene diisocyanate, xylylene diisocyanate, m-tetramethyl xylylene diisocyanate, 1,5-naphthalene diisocyanate, 4,4′-dibenzyl diisocyanate, and 1,3-phenylene diisocyanate; and amino acid diisocyanates such as lysine diisocyanate. These may be used alone or two or more thereof may be used in combination. In addition, as the component (a2), nurate components, adduct components or biuret components thereof may be used.

The ratio of the component (a1) and the component (a2) used is usually a ratio (NCO₍ₐ₂₎/OH₍ₐ₁₎ of the number of moles (NCO₍ₐ₂₎) of the isocyanate group of the component (a2) and the number of moles (OH (a n) of the hydroxy group of the component (a1), and the ratio is preferably about 1.1/1 to 8/1.

The component (a3) is a chain extender.

Examples of components (a3) include diamines such as ethylenediamine, propylenediamine, hexamethylenediamine, isophoronediamine, dimer diamine, dicyclohexylmethane-4,4′-diamine, 2-hydroxyethylethylenediamine, 2-hydroxyethylpropylenediamine, di-2-hydroxyethylethylenediamine, di-2-hydroxyethylpropylenediamine, 2-hydroxypropylethylenediamine, and di-2-hydroxypropylethylenediamine;
triamines such as diethylenetriamine, dipropylenetriamine, and diethylenetriamine; tetramines such as triethylenetetramine and tripropylene tetramine; N-alkyldialkanolamines such as N-methyldiethanolamine, N-ethyldiethanolamine, N-propyldiethanolamine, N-isopropyldiethanolamine, N-butyldiethanolamine, N-isobutyldiethanolamine, N-oleyldiethanolamine, N-stearyldiethanolamine, N-methyldiisopropanolamine, N-ethyldiisopropanolamine, N-propyldiisopropanolamine, and N-butyldiisopropanolamine;
hydrazine or hydrazine derivatives (adipic acid hydrazide, etc.); dialkanol alkanoic acids such as glyceric acid, dioxymaleic acid, dioxyfumaric acid, dimethylolacetic acid, dimethylolpropionic acid, dimethylolbutanoic acid, dimethylolpentanoic acid, and dimethylolhexanoic acid; and
aromatic hydroxycarboxylic acids such as 4,4-di(hydroxyphenyl)butanoic acid, 4,4-di(hydroxyphenyl)pentanoic acid, and 2,6-dioxybenzoic acid. These may be used alone or two or more thereof may be used in combination. Among these, a dialkanol alkanoic acid is preferable because the produced component (A) is easily dissolved or dispersed in water.

Here, a quaternizing salt may be used as the dialkanolamine. The quaternizing salt is a component obtained by reacting the dialkanolamine with a quaternizing agent, and examples of quaternizing agents include inorganic acids such as hydrochloric acid, sulfuric acid, and phosphoric acid; organic acids such as dimethyl sulfate, acetic acid, and propionic acid; and organic halides such as methyl chloride, benzyl chloride, and epichlorohydrin.

In addition, carboxyl groups of the dialkanol alkanoic acid and aromatic hydroxycarboxylic acid may be neutralized with a neutralizing agent.

Examples of neutralizing agents include alkali metal hydroxides such as sodium hydroxide and potassium hydroxide; ammonia; and organic amines such as trimethylamine, triethylamine, triethanolamine, triisopropanolamine, N,N-dimethylethanolamine, and N,N-diethylethanolamine. These may be used alone or two or more thereof may be used in combination.

The amount of the component (a3) used with respect to 100 weight % of the reaction component constituting the component (A) is usually 1 to 30 weight % and preferably 3 to 20 weight %.

The component (A) of the disclosure may further contain a (meth)acrylic acid hydroxyalkyl ester (a4) (hereinafter referred to as a component (a4)) as a reaction component.

Examples of components (a4) include 2-hydroxyethyl (meth)acrylate, 2-hydroxy n-propyl (meth)acrylate, 3-hydroxy n-propyl (meth)acrylate, 3-hydroxy n-butyl (meth)acrylate, 4-hydroxy n-butyl (meth)acrylate, and 6-hydroxy n-hexyl (meth)acrylate. These may be used alone or two or more thereof may be used in combination. Among these, a component having a hydroxyalkyl group having 2 to 3 carbon atoms is preferable, and 2-hydroxyethyl (meth)acrylate and 2-hydroxy n-propyl (meth)acrylate are more preferable.

The amount of the component (a4) used with respect to 100 weight % of the reaction component constituting the component (A) is usually 10 weight % or less and preferably 0.1 to 5 weight %.

The component (A) of the disclosure may further contain a (meth)acrylic acid alkyl ester having no hydroxyl group (a5) (hereinafter referred to as a component (a5)) as a reaction component.

Examples of components (a5) include methyl (meth)acrylate, ethyl (meth)acrylate, n-propyl (meth)acrylate, isopropyl (meth)acrylate, n-butyl (meth)acrylate, isobutyl (meth)acrylate, s-butyl (meth)acrylate, t-butyl (meth)acrylate, n-pentyl (meth)acrylate, cyclopentyl (meth)acrylate, n-hexyl (meth)acrylate, cyclohexyl (meth)acrylate, 2-ethylhexyl (meth)acrylate, n-octyl (meth)acrylate, isooctyl (meth)acrylate, n-decyl (meth)acrylate, isobornyl (meth)acrylate, isodecyl (meth)acrylate, lauryl (meth)acrylate, myristyl (meth)acrylate, isomyristyl (meth)acrylate, malmityl (meth)acrylate, stearyl (meth)acrylate, and isostearyl (meth)acrylate. These may be used alone or two or more thereof may be used in combination. Among these, a component having an alkyl group having 12 to 18 carbon atoms is preferable, and lauryl (meth)acrylate, myristyl (meth)acrylate, malmityl (meth)acrylate, and stearyl (meth)acrylate are more preferable.

The amount of the component (a5) used with respect to 100 weight % of the reaction component constituting the component (A) is usually 50 weight % or less and preferably 10 to 40 weight %.

The reaction component may further contain a chain extension inhibitor (a6) (hereinafter referred to as a component (a6)). Examples of components (a6) include monoalcohols such as methanol, ethanol, n-propyl alcohol, isopropyl alcohol, n-butyl alcohol, and isobutyl alcohol; monoamines such as ethylamine, n-propylamine, diethylamine, di n-propylamine, and di n-butylamine; and alkanol monoamines such as monoethanolamine and diethanolamine. These may be used alone or two or more thereof may be used in combination.

The amount of the component (a6) used with respect to 100 weight % of the reaction component constituting the component (A) is usually 5 weight % or less and preferably 3 weight % or less.

The component (A) is obtained by, for example, reacting the component (a1) and the component (a2) to produce a urethane prepolymer and then reacting the urethane prepolymer and the component (a3), and as necessary, the components (a4) to (a6).

Regarding the reaction conditions in the process of obtaining a urethane prepolymer, the temperature is usually about 40 to 150° C. and preferably about 60 to 100° C. In addition, the time is usually about 1 to 20 hours and preferably about 1 to 10 hours.

Next, regarding the conditions when the urethane prepolymer is reacted with the component (a3), and as necessary, the components (a4) to (a6), the temperature is usually about 20 to 100° C. and preferably about 30 to 80° C. In addition, the time is usually about 1 to 10 hours and preferably about 1 to 5 hours. Here, the mixing method and mixing order of respective components are not particularly limited.

These components (A) may be produced in the absence of a solvent or in the presence of a hydrophilic solvent.

Examples of hydrophilic solvents include ketones such as acetone, methyl ethyl ketone, methyl isobutyl ketone, isophorone, cyclohexanone, and methylcyclohexanone; alkylene glycol monoethers such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, propylene glycol mono n-butyl ether, and propylene glycol mono-t-butyl ether; alkoxy alcohols such as 3-methoxybutanol and 3-methoxy-3-methylbutanol; cellosolves such as methyl cellosolve, ethyl cellosolve, n-butyl cellosolve, and t-butyl cellosolve; cellosolve acetates such as methyl cellosolve acetate and ethyl cellosolve acetate; alkyl alcohols such as methanol, ethanol, n-propanol, isopropanol, n-butanol, isobutanol, s-butanol, and t-butanol; amides such as N,N-dimethylformamide and N,N-dimethylacetamide; amines such as N-methylpyrrolidone; water such as deionized water, ultrapure water, pure water, purified water, tap water, soft water, hard water, and industrial water; and dimethyl sulfoxide. These may be used alone or two or more thereof may be used in combination. In addition, after the reaction is completed, the solvent may be distilled off under a reduced pressure or the like.

The amount of the solvent used is preferably adjusted so that the reaction concentration is 10 weight % or more.

In addition, in the above reaction, a component (B) to be described below may be added.

The component (A) may further include additives such as a pigment, a water retention agent, an antifoaming agent, a preservative, a leveling agent, a colorant, an anti-blocking agent, an antioxidant, a plasticizer, a curing agent, a UV absorber, a thickener, an emulsifier, a dispersant, and a filler. These additives may be used alone or two or more thereof may be used in combination.

The weight-average molecular weight of the obtained component (A) is 5,000 to 2,000,000. Here, the weight-average molecular weight is a value measured by a gel permeation chromatography method (GPC method) using polystyrene as a standard substance.

In addition, the viscosity of the solution of the component (A) having a non-volatile content concentration of 35 weight % at a temperature of 25° C. is usually 5 to 20,000 mPa·s and preferably 10 to 10,000 mPa·s. Here, “viscosity” is a value measured using a B-type viscometer.

The aqueous heat-sealable resin composition of the disclosure may further contain a wax (B) (hereinafter referred to as a component (B)). When the component (B) is added, the coating of the aqueous heat-sealable resin composition tends to exhibit excellent blocking resistance. In addition, examples of forms of the component (B) include a solid, a liquid, and an emulsion.

Examples of components (B) include natural waxes such as an animal wax, a plant wax, a petroleum wax, and a mineral wax; and synthetic waxes such as a synthetic hydrocarbon wax, a modified wax, and a hydrogenated wax.

Examples of animal waxes include beeswax, a Chinese wax, and spermaceti.

Examples of plant waxes include carnauba, a rice wax, a candelilla wax, and a Japan wax.

Examples of petroleum waxes include a paraffin wax, a microcrystalline wax, and petrolatum.

Examples of mineral waxes include a montan wax, a ceresin wax, and ozokerite.

Examples of synthetic hydrocarbon waxes include a polyethylene wax, a polyethylene oxide wax, a polypropylene oxide wax, and a Fischer-Tropsch wax.

Examples of modified waxes include montan wax derivatives, paraffin wax derivatives, and microcrystalline wax derivatives.

Examples of hydrogenated waxes include a hydrogenated castor oil and hydrogenated castor oil derivatives.

In addition, examples of components (B) include an alkyl ketene dimer-based wax and a polytetrafluoroethylene wax.

The components (B) may be used alone or two or more thereof may be used in combination. Among these, plant wax and petroleum wax are preferable.

In addition, the component (B) may further contain additives such as a pigment, a water retention agent, an antifoaming agent, a preservative, a leveling agent, a colorant, an anti-blocking agent, an antioxidant, a UV absorber, a thickener, an emulsifier, a dispersant, a filler and the like. These additives may be used alone or two or more thereof may be used in combination.

Examples of weight ratios of the component (A) and the component (B) used in terms of the non-volatile content weight (the same applies below) include (A)/(B)=100/0, 99/1, 98/2, 97/3, 96/4, 95/5, 94/6, 93/7, 92/8, 91/9, 90/10, 87.5/12.5, 85/15, 82.5/17.5, 80/20, 77.5/22.5, 75/25, 72.5/27.5, 70/30, 67.5/32.5, 65/35, 62.5/37.5, 60/40, 57.5/42.5, 55/45, 52.5/47.5, and 50/50. Among these, the weight ratio is preferably (A)/(B)=100/0 to 50/50 and more preferably (A)/(B)=100/0 to 70/30 because a coating easily exhibits a high heat sealing strength. Here, the non-volatile content is a component remaining after removing volatile components such as a hydrophilic solvent.

The aqueous heat-sealable resin composition of the disclosure is obtained by mixing the component (A) and the component (B), and as necessary, water. Regarding mixing conditions, for example, the temperature is 10 to 90° C. (preferably 20 to 80° C.). In addition, the mixing order, the mixing method, and the mixing time for respective components are not particularly limited.

In addition, the aqueous heat-sealable resin composition of the disclosure may further contain additives such as a pigment, a water retention agent, an antifoaming agent, a preservative, a leveling agent, a colorant, an anti-blocking agent, an antioxidant, a UV absorber, a thickener, an emulsifier, a dispersant, a filler and the like. These additives may be used alone or two or more thereof may be used in combination.

Regarding physical properties of the obtained aqueous heat-sealable resin composition, the non-volatile content concentration is usually 10 to 60 weight % and preferably 20 to 50 weight %.

In addition, the viscosity of the solution of the aqueous heat-sealable resin composition having a non-volatile content concentration of 30 weight % at a temperature of 25° C. is usually 10 to 2,000 mPa·s and preferably 20 to 1,000 mPa·s. In addition, the viscosity here is a value measured using a B-type viscometer.

The laminate of the disclosure has a coating of the aqueous heat-sealable resin composition on at least one surface of a substrate.

The laminate is obtained by, for example, a method of applying an aqueous heat-sealable resin composition to at least one surface of a substrate and drying it.

Examples of substrates include base paper, a support film, and a metal plate.

Examples of base paper include those made from chemical pulps such as hardwood pulp (LBKP) and softwood pulp (NBKP); mechanical pulps such as ground pulp (GP), refiner ground pulp (RGP), and thermomechanical pulp (TMP); DIP, mercerized pulp, recycled pulp and the like by various paper machines, and more specific examples thereof include bleached kraft paper, unbleached kraft paper, woodfree paper, medium quality paper, finely coated paper, coated paper, processed base paper, paperboard, white paperboard, liner, semi-glassine paper, glassine paper, and parchment paper. In addition, the pulp containing pH adjusting agents such as aluminum sulfate, sulfuric acid and sodium hydroxide; paper strengthening agents such as a sizing agent, starch and polyacrylamide, and papermaking chemicals such as a wet paper strengthening agent; and fillers such as talc, clay, kaolin, titanium dioxide, and calcium carbonate may be used.

Examples of support films include polyimide resins such as a polyimide and a polyimide-silica hybrid; polyolefin resins such as polyethylene, polypropylene, and a cycloolefin polymer; polyester resins such as polyethylene terephthalate, polyethylene naphthalate, polybutylene succinate, polybutylene succinate adipate, polybutylene adipate terephthalate, polyhydroxyalkanoate, and polylactic acid; acrylic resins such as polymethyl methacrylate; fluorine-based resins such as polytetrafluoroethylene (PTFE), perfluoroalkoxy alkane (PFA), and polyvinylidene fluoride (PVDF); aromatic polyester resins obtained from ethylene terephthalate, phenol, phthalic acid, hydroxynaphthoic acid or the like and p-hydroxybenzoic acid (so-called liquid crystal polymer; “Vecstar,” or the like commercially available from Kuraray Co., Ltd.); cellulose resins such as acetyl cellulose and cellophane; and polystyrene resins, polycarbonate resins, acrylonitrile-butadiene-styrene resins and the like. These may be used alone or two or more thereof may be used in combination.

Examples of metal plates include aluminum-based metal plates such as an aluminum plate, an aluminum-plated steel plate, and an Al—Si alloy-plated steel plate; zinc-based metal plates such as a zinc-plated steel plate, a Zn—Fe alloy-plated steel plate, a Zn—Co alloy-plated steel plate, a Zn—Co—Cr alloy-plated steel plate, a Zn—Cr—Ni alloy-plated steel plate, a Zn—Cr—Fe alloy-plated steel plate, a Zn—Al alloy-plated steel plate, a Zn—Mg alloy-plated steel plate, a Zn—Al—Mg alloy-plated steel plate, and a Zn—Ni alloy-plated steel plate; a copper plate, a steel plate, a titanium plate, a stainless steel plate, a tin plate, a nickel-plated steel plate, a chromium-plated steel plate, and a phosphate-treated steel plate. These may be used alone or two or more thereof may be used in combination.

In addition, as the base paper, the support film or the metal plate, one in which an anchor layer, a filling layer, a water resistant layer, an oil resistant layer, a barrier layer, an antistatic layer or the like is additionally provided on one surface or both surfaces thereof may be used.

Examples of a method of applying an aqueous heat-sealable resin composition include methods using a bar coater, a knife coater, a size press coater, a roll coater, a reverse roll coater, a curtain coater, a gravure coater, a flexo coater, an air knife coater, a calendar, a gate roll coater, a blade coater, a 2-roll size press, rod metering and the like. In addition, the coating amount of the aqueous heat-sealable resin composition (in terms of the non-volatile content) is not particularly limited and is usually about 0.1 to 10 g/m 2 and preferably about 1 to 7 g/m 2.

The substrate after application is dried by heat, air blowing, or natural drying. Examples of heat sources include a hot air dryer, an infrared heater, and a rotary dryer. In addition, regarding the drying conditions, for example, the temperature is 80 to 220° C. (preferably 100 to 200° C.), and the time is 1 second to 180 minutes (preferably 30 seconds to 60 minutes).

### EXAMPLES

Hereinafter, the disclosure will be described in more detail with reference to examples, but the disclosure is not limited to these examples. Here, unless otherwise specified, all parts and % in examples are based on mass.

### Example 1: Preparation of Urethane Resin (A-1)

59.4 parts of dimethylolbutanoic acid, 489.9 parts of polytetramethylene glycol (product name: “PTMG1000,” a number-average molecular weight of 1,000, commercially available from Mitsubishi Chemical Corporation), 275.5 parts of isophorone diisocyanate, and 2.0 parts of 2-hydroxyethyl acrylate were put into a reaction container including a stirrer, a thermometer, a cooling pipe and a nitrogen gas introduction pipe and reacted under a nitrogen gas stream at 85° C. for 5 hours to obtain 826.8 parts of a urethane prepolymer. Next, the urethane prepolymer was added to and dispersed in an aqueous solution containing 1,300.0 parts of water, 225.0 parts of isopropyl alcohol, 40.5 parts of triethylamine, and 37.5 parts of adipic acid dihydrazide with stirring and reacted at 50° C. for 3 hours. Next, 0.1 parts of V-50 (commercially available from FUJIFILM Wako Pure Chemical Corporation) was added thereto and reacted at 80° C. for 1 hour. In addition, a predetermined amount of water was added to obtain a urethane resin (A-1) having a non-volatile content concentration of 35%, a viscosity of 300 mPa·s, and a pH of 8.0.

### Example 2: Preparation of Urethane Resin (A-2)

59.4 parts of dimethylolbutanoic acid, 489.9 parts of polytetramethylene glycol (product name: “PTMG1000,” a number-average molecular weight of 1,000, commercially available from Mitsubishi Chemical Corporation), and 285.5 parts of isophorone diisocyanate were put into the same reaction container as in Example 1 and reacted under a nitrogen gas stream at 85° C. for 5 hours to obtain 834.8 parts of a urethane prepolymer. Next, the urethane prepolymer was added to and dispersed in an aqueous solution containing 1,365.0 parts of water, 225.0 parts of isopropyl alcohol, 40.5 parts of triethylamine, and 65.0 parts of adipic acid dihydrazide with stirring. The mixture was reacted at 50° C. for 3 hours, and a predetermined amount of water was additionally added to obtain a urethane resin (A-2) having a non-volatile content concentration of 35%, a viscosity of 1,500 mPa·s, and a pH of 8.0.

### Example 3: Preparation of Urethane Resin (A-3)

59.4 parts of dimethylolpropionic acid, 489.9 parts of polytetramethylene glycol (product name: “PTMG1000,” a number-average molecular weight of 1,000, commercially available from Mitsubishi Chemical Corporation), 275.5 parts of isophorone diisocyanate, and 208.7 parts of methyl ethyl ketone were put into the same reaction container as in Example 1 and reacted under a nitrogen gas stream at 85° C. for 5 hours to obtain 1,043.5 parts of a urethane prepolymer. Next, the urethane prepolymer was added to and dispersed in an aqueous solution containing 1,230.0 parts of water, 100.0 parts of isopropyl alcohol, 44.7 parts of triethylamine, and 37.5 parts of adipic acid dihydrazide with stirring and reacted at 50° C. for 3 hours to obtain a urethane resin (A-3) having a non-volatile content concentration of 35%, a viscosity of 350 mPa·s, and a pH of 8.0.

### Example 4: Preparation of Urethane Resin (A-4)

59.4 parts of dimethylolbutanoic acid, 489.9 parts of Polycerin DCB-2000 (polyoxytetramethylene-polyoxypropylene glycol, a number-average molecular weight of 2,000, commercially available from NOF Corporation), and 200.8 parts of isophorone diisocyanate were put into the same reaction container as in Example 1 and reacted under a nitrogen gas stream at 85° C. for 5 hours to obtain 750.1 parts of a urethane prepolymer. Next, the urethane prepolymer was added to and dispersed in an aqueous solution containing 1,170.0 parts of water, 225.0 parts of isopropyl alcohol, 40.5 parts of triethylamine, and 43.3 parts of adipic acid dihydrazide with stirring and reacted at 50° C. for 3 hours, and a predetermined amount of water was additionally added to obtain a urethane resin (A-4) having a non-volatile content concentration of 35%, a viscosity of 500 mPa·s, and a pH of 8.0.

### Example 5: Preparation of Urethane Resin (A-5)

59.4 parts of dimethylolbutanoic acid, 489.9 parts of polytetramethylene glycol (product name: “PTMG1500,” a number-average molecular weight of 1,000, commercially available from Mitsubishi Chemical Corporation), and 250.0 parts of diphenylmethane diisocyanate were put into the same reaction container as in Example 1 and reacted under a nitrogen gas stream at 85° C. for 5 hours to obtain 750.3 parts of a urethane prepolymer. Next, the urethane prepolymer was added to and dispersed in an aqueous solution containing 1,208.0 parts of water, 225.0 parts of isopropyl alcohol, 40.5 parts of triethylamine, and 43.3 parts of adipic acid dihydrazide with stirring. The mixture was reacted at 50° C. for 3 hours and a predetermined amount of water was additionally added to obtain a urethane resin (A-5) having a non-volatile content concentration of 35%, a viscosity of 500 mPa·s, and a pH of 8.0.

### Example 6: Preparation of Urethane Resin (A-6)

38.1 parts of dimethylolbutanoic acid, 314.5 parts of Polycerin DCB-2000 (polyoxytetramethylene-polyoxypropylene glycol, a number-average molecular weight of 2,000, commercially available from NOF Corporation), 128.9 parts of isophorone diisocyanate, 12.7 parts of 2-hydroxyethyl acrylate, and 256.1 parts of stearyl methacrylate were put into the same reaction container as in Example 1 and reacted under a nitrogen gas stream at 85° C. for 5 hours to obtain 750.3 parts of a urethane prepolymer. Next, the urethane prepolymer was added to and dispersed in an aqueous solution containing 1,208.0 parts of water, 225.0 parts of isopropyl alcohol, 26.6 parts of triethylamine, and 27.8 parts of adipic acid dihydrazide with stirring and reacted at 50° C. for 3 hours. Next, 5.0 parts of V-601 (commercially available from FUJIFILM Wako Pure Chemical Corporation) was added and the mixture was reacted at 80° C. for 3 hours. A predetermined amount of water was additionally added to obtain a urethane resin (A-6) having a non-volatile content concentration of 35%, a viscosity of 300 mPa·s, and a pH of 8.0.

### Comparative Examples 1 and 2

A polycarbonate-based urethane resin (product name: “Superflex 460S,” commercially available from DKS Co., Ltd.) as Comparative Example 1 and a polyester-based urethane resin (product name: “Superflex 500M,” commercially available from DKS Co., Ltd.) as Comparative Example 2 were subjected to the following evaluations.

### Preparation of Coating Liquid

Deionized water was added to each urethane resin to prepare a coating liquid having a non-volatile content concentration of 30%.

### Preparation of Laminate

Each coating liquid was applied to kraft paper (product name: “HEIKO,” commercially available from Shimojima Co., Ltd., a basis weight of 70 g/m 2) using a meyer bar so that the solid content after drying was 7 g/m 2 and then dried at 100° C. for 30 seconds to obtain a laminate.

<Heat Sealing Strength>

Each laminate was cut into a size of 75 mm in length×110 mm in width, and the coated surface was folded inward in half lengthwise. The folded side was thermocompression-bonded with a seal width of 20 mm from the end using a heat sealing tester TP-701S (commercially available from Tester Sangyo Co., Ltd.) at a temperature of 130° C. and a pressure of 2 kgf/cm 2 for 1 second. This was divided into five equal parts to prepare five test pieces of 15 mm×55 mm. Each test piece was opened 180° from the seal part in the center and pulled vertically using a tensilon universal testing machine (device name: “RTG1210,” commercially available from A&D Co., Ltd.) at a gripper interval of 30 mm and a peeling speed of 300 mm/min, and the maximum load value was measured. The average value of the five test pieces was used as the value of the heat sealing strength (unit: N/15 mm). Table 1 shows the results.

TABLE 1

| | | Heat sealing |
|---|---|---|
| | Urethane | strength |
| | resin | (N/15 mm) |
| Example 1 | A-1 | 6.1 |
| Example 2 | A-2 | 6.0 |
| Example 3 | A-3 | 6.1 |
| Example 4 | A-4 | 5.8 |
| Example 5 | A-5 | 5.9 |
| Example 6 | A-6 | 5.2 |
| Comparative | C-1 | 3.8 |
| Example 1 | | |
| Comparative | C-2 | 4.5 |
| Example 2 | | |

The symbols shown in Table 1 are as follows.
A-1: polyether-based urethane resin of Example 1
A-2: polyether-based urethane resin of Example 2
A-3: polyether-based urethane resin of Example 3
A-4: polyether-based urethane resin of Example 4
A-5: polyether-based urethane resin of Example 5
A-6: polyether-based urethane resin of Example 6
C-1: polycarbonate-based urethane resin, product name: ″Superflex 460S,″ commercially available from DKS Co., Ltd.
C-2: polyester-based urethane resin, product name: ″Superflex 500M,″ commercially available from DKS Co., Ltd.

### Example 7

88.5 parts (non-volatile content: 31.0 parts) of the urethane resin (A-1), 11.5 parts (non-volatile content: 3.45 parts) of the paraffin wax (product name: “Sizepine W-116H,” non-volatile content concentration: 30%, commercially available from Arakawa Chemical Industries, Ltd.) and 12.9 parts of deionized water were mixed to obtain an aqueous heat-sealable resin composition.

### Examples 8 to 13

Aqueous heat-sealable resin compositions were obtained in the same manner as in Example 7 according to the formulations and non-volatile content weights shown in Table 2.

### Preparation of laminate

Laminates were obtained using the aqueous heat-sealable resin compositions of Examples 7 to 13 in the same method described in the preceding paragraph.

(Heat Sealing Strength)

Using the laminates obtained using the aqueous heat-sealable resin compositions of Examples 7 to 13, the heat sealing strength was measured in the same method described in the preceding paragraph. The results are shown in Table 2 (the same applies below).

<Blocking Resistance>

The laminates obtained using the aqueous heat-sealable resin compositions of Examples 7 to 13 were cut into a size of 20 mm in length×40 mm in width, two pieces were superimposed so that the coated surface and the uncoated surface were in contact with each other, and after pressing at a pressing pressure of 10 kgf/cm 2 for 30 minutes using a permanent strain tester (commercially available from Tester Sangyo Co., Ltd.) in an environment of a temperature of 40° C. and a humidity of 90%, the contact surfaces of the two superimposed laminates were held with two hands and peeled off and evaluated based on the following criteria.

### (Evaluation Criteria)

∘: the coated surface and the uncoated surface were cleanly peeled off without the material breaking.
x: the layer of the cured product on the side of the coated surface adhered to the side of the uncoated surface and was peeled off.

TABLE 2

| | | | | | Heat sealing | |
|---|---|---|---|---|---|---|
| | Urethane | | | | strength | Blocking |
| | resin | | Wax | | (N/15 mm) | resistance |
| Example 7 | A-1 | 90 | B-1 | 10 | 5.8 | ○ |
| Example 8 | A-1 | 90 | B-2 | 10 | 6.2 | ○ |
| Example 9 | A-1 | 90 | B-3 | 10 | 6.0 | ○ |
| Example | A-1 | 90 | B-4 | 10 | 6.0 | ○ |
| 10 | | | | | | |
| Example | A-1 | 80 | B-2 | 20 | 6.0 | ○ |
| 11 | | | | | | |
| Example | A-1 | 80 | B-1 | 10 | 5.9 | ○ |
| 12 | | | B-2 | 10 | | |
| Example | A-1 | 70 | B-2 | 30 | 5.8 | ○ |
| 13 | | | | | | |

The symbols shown in Table 2 are as follows.
B-1: paraffin wax, product name: “Sizepine W-116H,” non-volatile content concentration: 30%, commercially available from Arakawa Chemical Industries, Ltd.
B-2: carnauba wax, product name: “EMUSTAR-0413,” non-volatile content concentration: 35%, commercially available from Nippon Seiro Co., Ltd.
B-3: rice wax, product name: “XAQUASPROUT-0010,” non-volatile content concentration: 40%, commercially available from Nippon Seiro Co., Ltd.
B-4: microcrystalline wax, product name: “EMUSTAR-0001,” non-volatile content concentration: 40%, commercially available from Nippon Seiro Co., Ltd.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An aqueous heat-sealable resin composition comprising a urethane resin (A) which is a product of reaction components including a polyether polyol (a1), a polyisocyanate (a2) and a chain extender (a3).

2. The aqueous heat-sealable resin composition according to claim 1,
wherein the reaction component further includes a (meth)acrylic acid hydroxyalkyl ester (a4).

3. The aqueous heat-sealable resin composition according to claim 1, further comprising a wax (B).

4. A laminate having a coating of the aqueous heat-sealable resin composition according to claim 1 on at least one surface of a substrate.

5. The aqueous heat-sealable resin composition according to claim 2, further comprising a wax (B).

6. A laminate having a coating of the aqueous heat-sealable resin composition according to claim 2 on at least one surface of a substrate.
